(19) United States
(12) Patent Application Publication
(10) Pub. No.: US 2026/0287754 A1
(43) Pub. Date: Sep. 24, 2026

(54) METHODS AND APPARATUS FOR UPLINK TRANSMISSION EXTENSION AND MEASUREMENT GAP CONFIGURATION IN GLOBAL NAVIGATION SATELLITE SYSTEM OPERATION

(71) Applicant: MediaTek Singapore Pte. Ltd., Singapore (SG)

(72) Inventor: Wen TANG, Beijing (CN)

(73) Assignee: MediaTek Singapore Pte. Ltd., Singapore (SG)

(21) Appl. No.: 19/474,209

(22) PCT Filed: Jul. 24, 2024
(86) PCT No.: PCT/CN2024/107211

§ 371 Date: Oct. 10, 2025

(30) Foreign Application Priority Data
Sep. 8, 2023 (WO) PCT/CN2023/117735

(51) Int. Cl. G01S 19/24; H04W 24/08

(52) U.S. Cl. CPC G01S 19/24; H04W 24/08

(57) ABSTRACT

Various solutions for uplink (UL) transmission extension and measurement gap configuration in global navigation satellite system (GNSS) operation are described. An apparatus may connect to a network node of a wireless network to operate in a connected state with a GNSS validity duration. The apparatus may also receive a configuration of an extension duration from the network node. Then, the apparatus may determine that an UL transmission is allowed in the extension duration subsequent to an expiry of the GNSS validity duration.

### CROSS REFERENCE TO RELATED PATENT APPLICATION(S)

The present disclosure is part of a non-provisional application claiming the priority benefit of PCT Application No. PCT/CN2023/117735, filed 8 Sep. 2023, the content of which herein being incorporated by reference in its entirety.

### TECHNICAL FIELD

The present disclosure is generally related to mobile communications and, more particularly, to uplink (UL) transmission extension and measurement gap configuration in global navigation satellite system (GNSS) operation.

### BACKGROUND

Unless otherwise indicated herein, approaches described in this section are not prior art to the claims listed below and are not admitted as prior art by inclusion in this section.

In 3^{rd} Generation Partnership Project (3GPP) Release 17, non-terrestrial network (NTN) is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) UEs. NR NTN uses the 5G NR framework to enable direct connection between satellites and smartphones to provide voice and data services.

In scenarios with large transmission delay, such as the IoT NTN, to ensure normal system operation, the UE may need a valid GNSS position fix for time and frequency synchronization. According to current 3GPP Release 17 standards, to do GNSS position fix is that the UE needs to have a valid GNSS fix before entering radio resource control (RRC) connected state (also called RRC_CONNECTED mode), and when the GNSS fix becomes outdated in RRC connected state, the UE enters RRC idle state (also called RRC_IDLE mode). Yet, this design is not feasible for UE with potentially long UL transmission because additional re-access to network is needed, which is costing in terms of signaling overhead and delay. Later, in 3GPP Release 18, it is agreed that depending on UE mobility, the UE in RRC connected state may re-acquire a new GNSS position fix in order to accommodate the accumulated time and frequency errors to reduce the possible radio link failure. However, in current 3GPP Release 18 standards, details of GNSS operation have not been fully discussed and some issues need to be solved. For example, one of the issues relate to how to enhance overall efficiency in the case that the original GNSS validity duration expires without a GNSS re-acquisition. Furthermore, another issue relates to when to start the aperiodic GNSS measurement gap

Accordingly, how to enhance/ensure normal GNSS operation becomes an important issue for modern wireless communication systems. Therefore, there is a need to provide proper schemes to address these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to UL transmission extension and measurement gap configuration in GNSS operation. It is believed that the above-described issue would be avoided or otherwise alleviated by implementing one or more of the proposed schemes described herein.

In one aspect, a method may involve an apparatus connecting to a network node of a wireless network to operate in a connected state with a GNSS validity duration. The method may also involve the apparatus receiving a configuration of an extension duration from the network node. The method may further involve the apparatus determining that an UL transmission is allowed in the extension duration subsequent to an expiry of the GNSS validity duration.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising connecting, via the transceiver, to the network node of the wireless network to operate in a connected state with a GNSS validity duration. The processor may also perform operations comprising receiving, via the transceiver, a configuration of an extension duration from the network node. The processor may further perform operations comprising determining that an UL transmission is allowed in the extension duration subsequent to an expiry of the GNSS validity duration.

In one aspect, a method may involve an apparatus receiving a medium access control (MAC) control element (CE) from a network node of a wireless network, wherein the MAC CE indicates that a GNSS measurement gap is triggered. The method may also involve the apparatus determining that the GNSS measurement gap starts at a time equal to a value plus an end of a subframe or slot where a hybrid automatic repeat request (HARQ) feedback for the MAC CE is transmitted to the network node. The method may further involve the apparatus performing a GNSS measurement based on the GNSS measurement gap.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of component values of Y based on values of the time alignment timer in accordance with an implementation of the present disclosure.

FIG. 3 is a diagram depicting an example scenario of component values of Y based on values of the time alignment timer in accordance with another implementation of the present disclosure.

FIG. 4 is a diagram depicting an example scenario of component values of Y based on values of the GNSS validity duration in accordance with an implementation of the present disclosure.

FIG. 5 is a diagram depicting an example scenario of component values of Y based on values of the GNSS validity duration in accordance with another implementation of the present disclosure.

FIG. 6 is a diagram depicting an example scenario of the format of a GNSS measurement trigger MAC CE in accordance with an implementation of the present disclosure.

FIG. 7 is a diagram depicting an example scenario of component values of X2 as a configured parameter in accordance with another implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UL transmission extension and measurement gap configuration in GNSS operation. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

In NTN systems (e.g., IoT NTN systems), due to large time delay and Doppler frequency shift, the UE may need to perform pre-compensation of time delay and frequency offset based on the UE's GNSS position and ephemeris related parameters. To reduce the possible radio link failure during GNSS operation, a GNSS position fix may be re-acquired in long connection time. Moreover, when the frequency error and timing error of the UE's GNSS position are within the frequency and timing error requirements with legacy closed loop time correction, UL transmission may be allowed in an extension duration X after the original GNSS validity duration expires without a GNSS re-acquisition. However, in current 3GPP Release 18 standards, details of GNSS operation have not been fully discussed and some issues need to be solved, such as how to configure the extension duration X properly to realize the UL transmission extension after the original GNSS validity duration expires without a GNSS re-acquisition. Additionally, another issue relates when to start the aperiodic GNSS measurement gap triggered by network.

In view of the above, the present disclosure is motivated by, but not limited to, an IoT NTN scenario, and accordingly proposes a number of schemes pertaining to UL transmission extension and measurement gap configuration in GNSS operation. According to the schemes of the present disclosure, procedures for configuring the extension duration X and the GNSS measurement gap in the connected state are proposed to ensure normal operation in NTN systems. Specifically, for the extension duration X, if the time alignment timer (referred to herein as timeAlignmentTimer) is not configured to be infinity, the value of X is equal to remaining value of the timeAlignmentTimer. Otherwise, if the timeAlignmentTimer is configured to be infinity, the value of X is equal to Y. Moreover, for the aperiodic GNSS measurement gap triggered by network with a MAC CE, the start time of the gap may be at p+X2, where p is the end of HARQ feedback transmission subframe/slot when HARQ feedback for the MAC CE is enabled, and X2 may be a predefined or configured value.

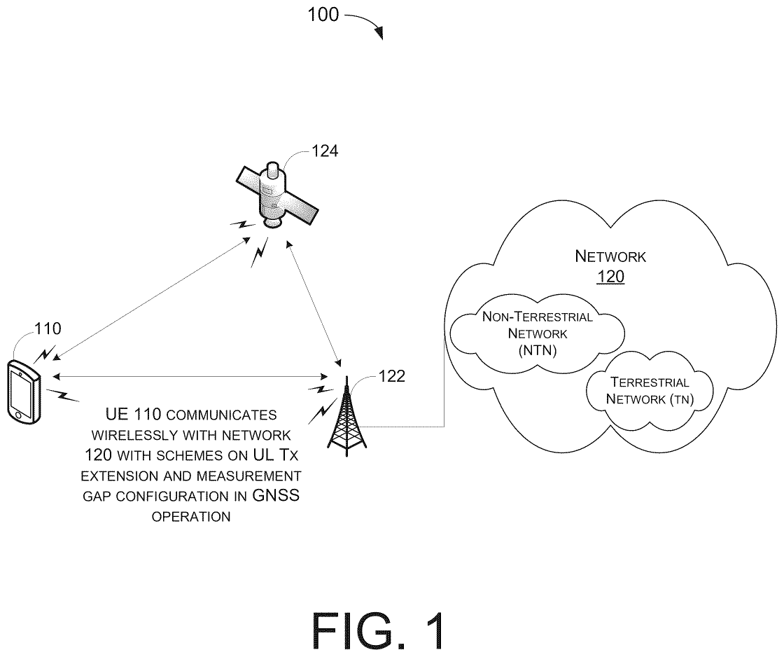

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 122 (e.g., an evolved Node-B (eNB), a Next Generation Node-B (gNB), or a transmission/reception point (TRP)) and/or a non-terrestrial network node 124 (e.g., a satellite). For example, the terrestrial network node 122 and/or the non-terrestrial network node 124 may form an NTN serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 122, and the non-terrestrial network node 124 may implement various schemes pertaining to UL transmission (Tx) extension and measurement gap configuration in GNSS operation in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In general, an IoT system is mainly divided into NB-IoT and eMTC based on differences in system bandwidth and coverage. Typically, the bandwidth used in NB-IoT is about 200 kilo-hertz (KHz) and supports the transmission of low traffic data at a rate below 100 kilobits per second (Kbps). Conversely, eMTC technology typically utilizes 1.4 mega-hertz (MHz) bandwidth and the maximum data transmission rate is 1 megabits per second (Mbps).

Under a first proposed scheme in accordance with the present disclosure, component values for Y are proposed for the extension duration X, where X equals to Y when the timeAlignmentTimer is configured to be infinity. Specifically, Y may be configured by a 1-bit, 2-bit, 3-bit, or 4-bit higher layer (e.g., radio resource control (RRC)) parameter.

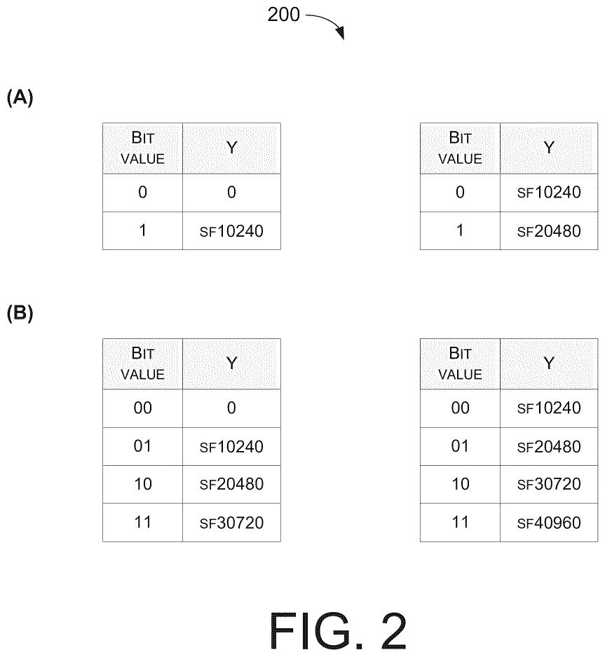

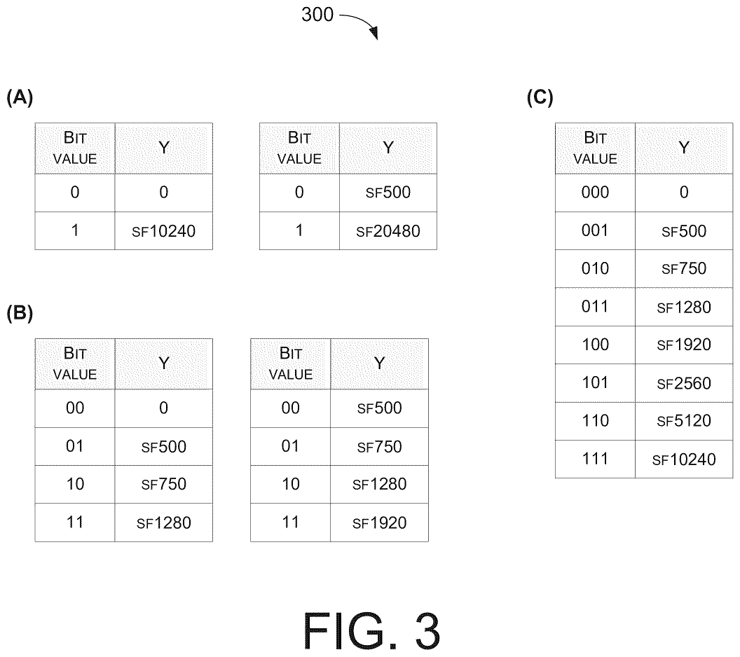

In some implementations, the component values of Y may be based on values of the timeAlignmentTimer (i.e., value in number of sub-frames (e.g., value sf500 corresponds to 500 sub-frames)). For example, the component values are times of sf10240, as shown in FIG. 2, where part (A) depicts two example cases of using a 1-bit field to indicate the component values of Y, while part (B) depicts two example cases of using a 2-bit field to indicate the component values of Y. For another example, the component values are from values of timeAlignmentTimer and 0, as shown in FIG. 3, where part (A) depicts two example cases of using a 1-bit field to indicate the component values of Y, part (B) depicts two example cases of using a 2-bit field to indicate the component values of Y, and part (C) depicts an example case of using a 3-bit field to indicate the component values of Y.

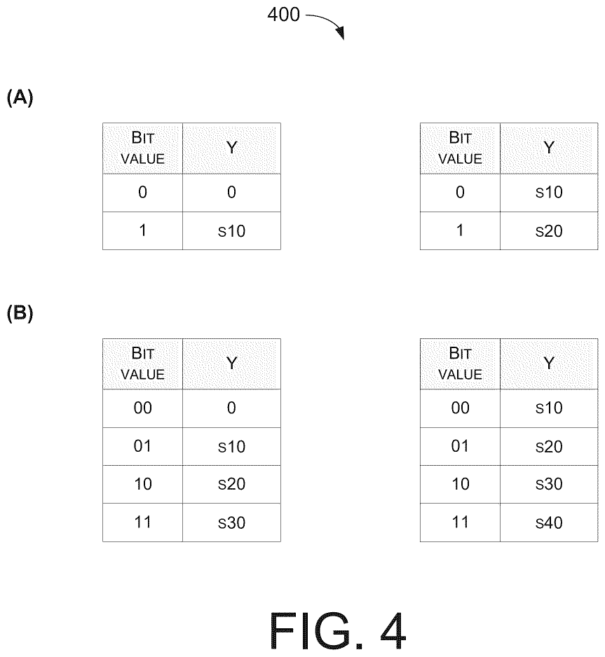

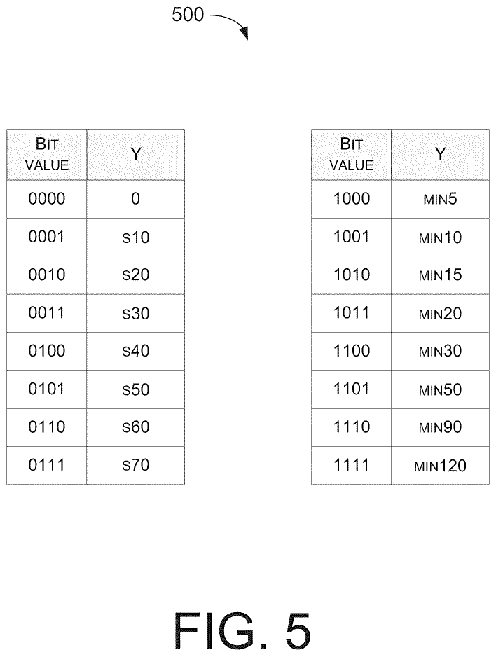

In some implementations, the component values of Y may be based on values of the GNSS validity duration (indicated by the GNSS-ValidityDuration information element (IE)) (e.g., value s10 corresponds to 10 seconds, s20 corresponds to 20 seconds, and so on, and/or value min 5 corresponds to 5 minutes, value min 10 corresponds to 10 minutes, and so on). For example, the component values are times of s10, as shown in FIG. 4, where part (A) depicts two example cases of using a 1-bit field to indicate the component values of Y, while part (B) depicts two example cases of using a 2-bit field to indicate the component values of Y. For another example, the component values are from values of GNSS-ValidityDuration and 0, as shown in FIG. 5, where an example case of using a 4-bit field to indicate the component values of Y is depicted.

Under a second proposed scheme in accordance with the present disclosure, the configuration mechanisms for Y are proposed for the extension duration X, where X equals to Y when the timeAlignmentTimer is configured to be infinity. Specifically, Y may be cell-specific parameter configured by a system information block (SIB) or an RRC signaling, or Y may be UE-specific parameter configured by an RRC signaling, a medium access control (MAC) control element (CE), or a downlink control information (DCI).

In some implementations, Y may be configured by a SIB or an RRC signaling. For example, in option 1, Y may be configured in a SystemInformationBlockType2-NB IE for NB-IoT or in a SystemInformationBlockType2 IE for eMTC. In option 2, Y may be configured in a MAC-MainConfig-NB IE for NB-IoT or in a MAC-MainConfig IE for eMTC. In option 3, Y may be configured in a SystemInformationBlockType31-NB IE for NB-IoT or in a SystemInformationBlockType31 IE for eMTC. In option 4, Y may be configured in a new SIB.

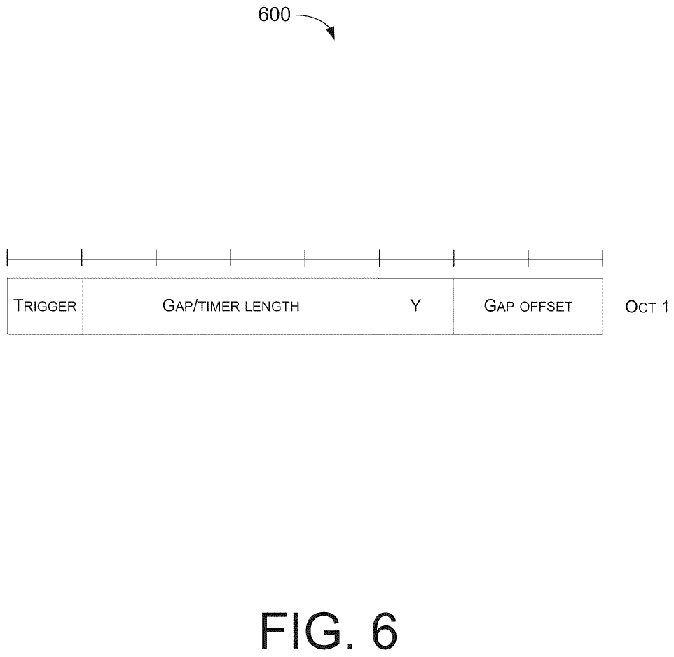

In some implementations, Y may be configured by a MAC CE or DCI. For example, in option 1, Y may be configured by a GNSS measurement trigger MAC CE when the trigger information for GNSS measurement gap is 0 or default, which indicates that GNSS measurement gap is not triggered. In option 2, Y may be configured in a new MAC CE. In option 3, Y may be configured in a new DCI field or in a re-interpret DCI field. FIG. 6 illustrates an example scenario 600 of the format of a GNSS measurement trigger MAC CE in accordance with an implementation of the present disclosure. Scenario 600 depicts only the first octet of the MAC CE, but the format of the MAC CE may include more octets. As shown in FIG. 6, the first field (denoted as “Trigger”) is a 1-bit field used to carry the trigger information for GNSS measurement gap. When this field is set to 0 or default, it indicates that GNSS measurement gap is not triggered. Otherwise, when this field is set to 1, it indicates that GNSS measurement gap is triggered. The second field (denoted as “Gap/timer length”) is used to carry the length information for GNSS measurement gap/timer, and it is a 4-bit field with component values of 1, 2, 3, 4, 5, 6, 7, 13, 19, 25, and 31 seconds. The third field (denoted as “Y”) is used to carry the value information Y for the extension duration X where UL transmission may be allowed after the original GNSS validity duration expires without a GNSS re-acquisition. The fourth field (denoted as “GAP offset”) is used to carry the GAP offset information for the start time of a GNSS measurement gap.

In some implementations, Y may not be configured. In option 1, when Y is not configured, it implicitly indicates that the mechanisms, to allow UL transmission after the original GNSS validity duration expires without a GNSS re-acquisition for some duration, is disabled or is not configured by network (e.g., eNB). In option 2, when Y is not configured and another higher layer parameter (e.g., ULtransmissionExtention or ul-TransmissionExtensionEnabled) indicates that the mechanisms, to allow UL transmission after the original GNSS validity duration expires without a GNSS re-acquisition for some duration, is enabled or configured by network (e.g., eNB), then the default value of Y is Z, where Z can be sf10240 or s10. The higher layer parameter ULtransmissionExtention (or named ul-TransmissionExtensionEnabled) may be configured in a eMTC, or may be configured in a new SIB for both NB-IoT and eMTC. Alternatively, the higher layer parameter ULtransmissionExtention (or named ul-TransmissionExtensionEnabled) may be configured in a dedicated RRC parameter, e.g. Msg5, for both NB-IoT and eMTC. Furthermore, the higher layer parameter ULtransmissionExtention (or named ul-TransmissionExtensionEnabled) may be configured in a MAC CE, e.g. GNSS measurement trigger MAC CE, for both NB-IoT and eMTC where the trigger information for GNSS measurement gap in the MAC CE is set to 0 or default, which indicates that GNSS measurement gap is not triggered.

Under a third proposed scheme in accordance with the present disclosure, the extension duration X may be implemented as a GNSS validity duration extension. The operation procedure for the extension duration X, where UL transmission may be allowed after the original GNSS validity duration expires without a GNSS re-acquisition, may be the same as the operation procedure before the original GNSS validity duration expires. Specifically, upon indication that the original GNSS position has become out-of-date while in RRC_CONNECTED, the UE may perform one of the following: (i) if ULtransmissionExtention (or named ul-TransmissionExtensionEnabled) indicates that the mechanisms, to allow UL transmission after the original GNSS validity duration expires without a GNSS re-acquisition for some duration, is disabled by network (e.g., eNB), and if GNSSAutonomousEnable indicates that the autonomous GNSS re-acquisition mechanism is disabled by network (e.g., eNB) and no GNSS measurement gap trigger is received, then the UE performs the actions upon leaving RRC_CONNECTED as specified in 3GPP technical specifications, with release cause set to ‘other’; and (ii) if ULtransmissionExtention (or named ul-TransmissionExtensionEnabled) indicates that the mechanisms, to allow UL transmission after original GNSS validity duration expires without GNSS re-acquisition for some duration, is enabled by network (e.g., eNB), and if the duration X, where UL transmission may be allowed after the original GNSS validity duration expires without a GNSS re-acquisition is expired, and if GNSSAutonomousEnable indicates that the autonomous GNSS re-acquisition mechanism is disabled by network (e.g., eNB) and no GNSS measurement gap trigger is received, then the UE performs the actions upon leaving RRC_CONNECTED as specified in 3GPP technical specifications, with release cause set to ‘other’.

Under a fourth proposed scheme in accordance with the present disclosure, the extension duration X may be implemented as a timer. The operation procedure for the extension duration X, where UL transmission may be allowed after the original GNSS validity duration expires without a GNSS re-acquisition, may be the same as the operation procedure before the original GNSS validity duration expires. A new timer T3xx (e.g., T390) corresponding to the duration X may be introduced. Specifically, upon indication that the GNSS position has become out-of-date while in RRC_CONNECTED, the UE may perform one of the following: (i) if T3xx is not configured, and if GNSSAutonomousEnable indicates that the autonomous GNSS re-acquisition mechanism is disabled by network (e.g., eNB) and no GNSS measurement gap trigger is received, then the UE performs the actions upon leaving RRC_CONNECTED as specified in 3GPP technical specifications, with release cause set to ‘other’; and (ii) if T3xx is configured and expired, and if GNSSAutonomousEnable indicates that the autonomous GNSS re-acquisition mechanism is disabled by network (e.g., eNB) and no GNSS measurement gap trigger is received, then the UE performs the actions upon leaving RRC_CONNECTED as specified in 3GPP technical specifications, with release cause set to ‘other’.

Under a fifth proposed scheme in accordance with the present disclosure, X2 may be implemented as a predefined value. For example, in option 1, X2 equals to 1 milli-seconds (ms) for both NB-IoT and eMTC. In option 2, X2 equals to 3 ms for both NB-IoT and eMTC. In option 3, X2 equals to 12 ms for both NB-IoT and eMTC. In option 4, X2 equals to 12 ms for NB-IoT and equals to 3 ms for eMTC.

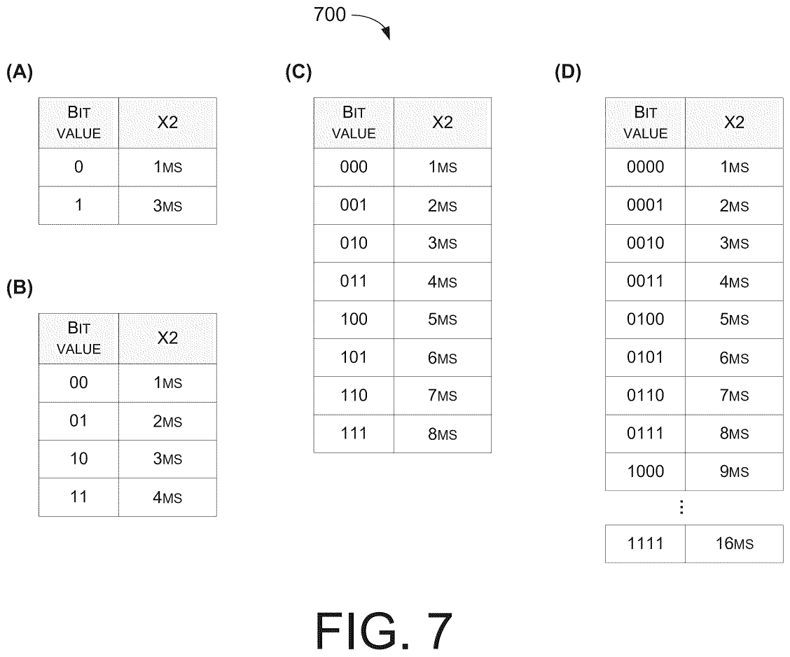

Under a sixth proposed scheme in accordance with the present disclosure, X2 may be implemented as a configured value. Specifically, X2 may be configured by a 1/2/3/4 bit(s) higher layer parameter, as shown in FIG. 7, where part (A) depicts an example case of using a 1-bit field to indicate the component values of X2, part (B) depicts an example case of using a 2-bit field to indicate the component values of X2, part (C) depicts an example case of using a 3-bit field to indicate the component values of X2, and part (D) depicts an example case of using a 4-bit field to indicate the component values of X2. For example, in option 1, X2 may be configured in a dedicated RRC parameter, e.g. Msg5, for both NB-IoT and eMTC. In option 2, X2 may be configured in a SIB.

### Illustrative Implementations

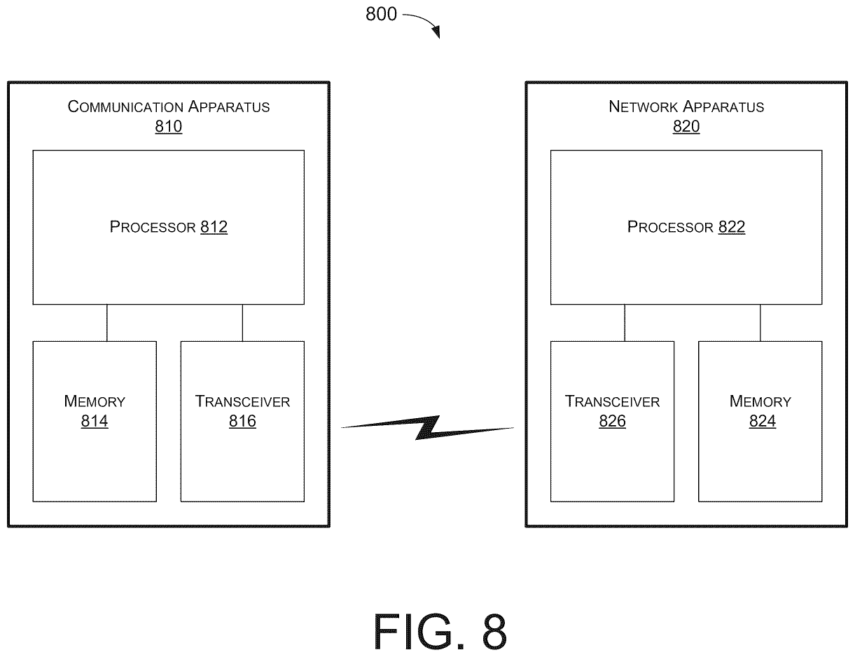

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to UL transmission extension and measurement gap configuration in GNSS operation, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 810 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a satellite, a base station (BS), a small cell, a router or a gateway of an NTN. For instance, network apparatus 820 may be implemented in a satellite or an eNB/gNB/TRP in a 4G/5G, NR, IoT, NB-IoT or IIoT network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks, including UL transmission extension and measurement gap configuration in GNSS operation, in a device (e.g., as represented by communication apparatus 810) and a network node (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, transceiver 816 may be capable of wirelessly communicating with different types of UEs and/or wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, network apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, communication apparatus 810 may further include a memory 814 coupled to processor 812 and capable of being accessed by processor 812 and storing data therein. In some implementations, network apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random access memory (NVRAM) such as flash memory, solid-state memory, ferroelectric RAM (FeRAM), magnetoresistive RAM (MRAM) and/or phase-change memory.

Each of communication apparatus 810 and network apparatus 820 may be a communication entity capable of communicating with each other using various proposed schemes in accordance with the present disclosure. For illustrative purposes and without limitation, a description of capabilities of communication apparatus 810, as a UE, and network apparatus 820, as a network node, is provided below with processes 900 and 1000.

### Illustrative Processes

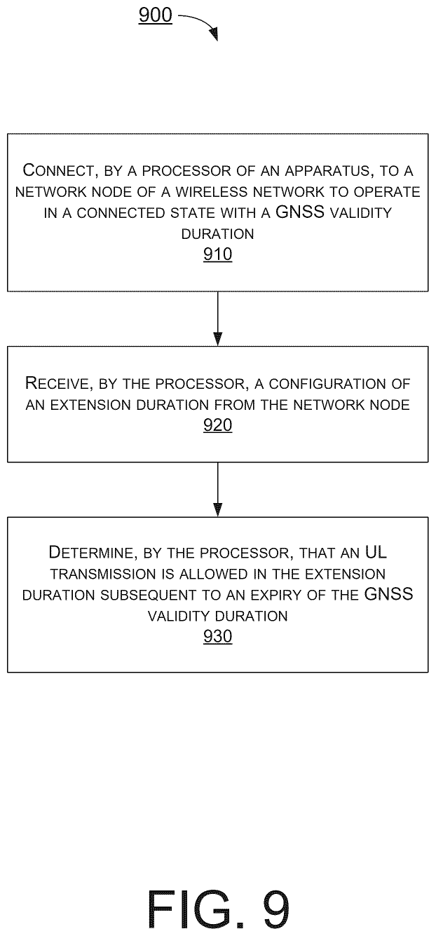

FIG. 9 illustrates an example process 900 in accordance with an implementation of the present disclosure. Process 900 may be an example implementation of above scenarios/schemes, whether partially or completely, with respect to UL transmission extension in GNSS operation. Process 900 may represent an aspect of implementation of features of communication apparatus 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by or in communication apparatus 810 or any suitable UE or machine type devices. Solely for illustrative purposes and without limitation, process 900 is described below in the context of communication apparatus 810, as a UE, and network apparatus 820, as a network node. Process 900 may begin at block 910.

At block 910, process 900 may involve processor 812 of communication apparatus 810 connecting, via transceiver 816, to network apparatus 820 of a wireless network to operate in a connected state (e.g., RRC_CONNECTED mode) with a GNSS validity duration. Process 900 may proceed from block 910 to block 920.

At block 920, process 900 may involve processor 812 receiving, via transceiver 816, a configuration of an extension duration from network apparatus 820. Process 900 may proceed from block 920 to block 930.

At block 930, process 900 may involve processor 812 determining that an UL transmission is allowed in the extension duration subsequent to an expiry of the GNSS validity duration.

In some implementations, the configuration of the extension duration may be received via a dedicated RRC signaling.

In some implementations, the dedicated RRC signaling may include an IE for a time alignment timer (e.g., timeAlignmentTimer), and a value of the extension duration may be determined based on a remaining time of the time alignment timer in an event that the time alignment timer is not

In some implementations, the configuration of the extension duration indicates a value of the extension duration to be applied in an event that a time alignment timer is configured to be infinity.

In some implementations, the configuration of the extension duration may include a 3-bit field indicating the value of the extension duration.

In some implementations, process 900 may further involve processor 812 starting a timer (e.g., T3xx) with a value of the extension duration, and leaving the connected state in an event that the timer expires, no indication of a network triggered GNSS measurement has been received, and autonomous GNSS re-acquisition is disabled.

In some implementations, the determining that the UL transmission is allowed in the extension duration subsequent to the expiry of the GNSS validity duration may be performed in an event that a frequency error and a timing error of a GNSS position associated with the GNSS validity duration are within frequency and timing error requirements with a closed loop time correction.

In some implementations, process 900 may further involve processor 812 determining that the UL transmission is not allowed after the expiry of the GNSS validity duration, in an event that the configuration of the extension duration is not received. Alternatively, process 900 may further involve processor 812 determining that the UL transmission is allowed in the extension duration subsequent to the expiry of the GNSS validity duration, in an event that the configuration of the extension duration is not received and an indication of enabling UL transmission extension is received, wherein the extension duration is set to a predetermined value.

In some implementations, the indication of enabling UL transmission extension is received via a dedicated RRC signaling.

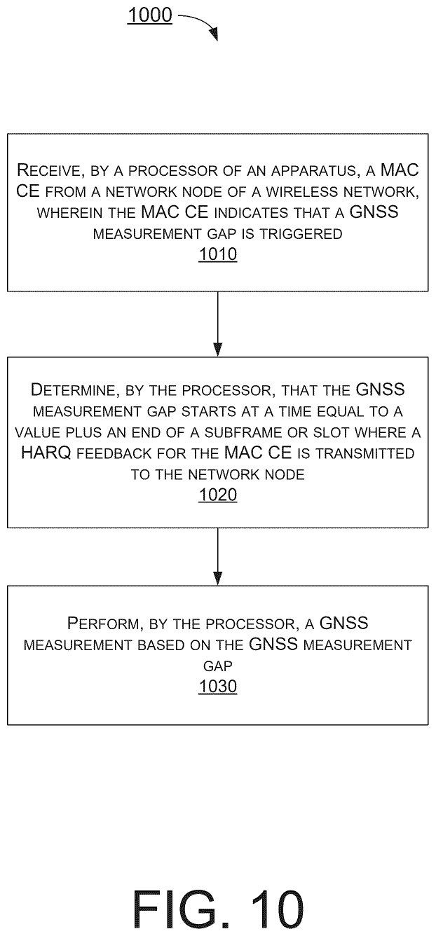

FIG. 10 illustrates an example process 1000 in accordance with an implementation of the present disclosure. Process 1000 may be an example implementation of above scenarios/schemes, whether partially or completely, with respect to measurement gap configuration in GNSS operation. Process 1000 may represent an aspect of implementation of features of communication apparatus 810. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by or in communication apparatus 810 as well as any variations thereof. Solely for illustrative purposes and without limitation, process 1000 is described below in the context of communication apparatus 810, as a UE, and network apparatus 820, as a network node. Process 1000 may begin at block 1010.

At block 1010, process 1000 may involve processor 812 of communication apparatus 810 receiving, via transceiver 816, a MAC CE from network apparatus 820 of a wireless network, wherein the MAC CE indicates that a GNSS measurement gap is triggered. Process 1000 may proceed from block 1010 to block 1020.

At block 1020, process 1000 may involve processor 812 determining that the GNSS measurement gap starts at a time equal to a value plus an end of a subframe or slot where a HARQ feedback for the MAC CE is transmitted to network apparatus 820. Process 1000 may proceed from

At block 1030, process 1000 may involve processor 812 performing, via transceiver 816, a GNSS measurement based on the GNSS measurement gap.

In some implementations, the value may be predefined to be 2 ms or may be configured via an RRC signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
connecting, by a processor of an apparatus, to a network node of a wireless network to operate in a connected state with a global navigation satellite system (GNSS) validity duration;
receiving, by the processor, a configuration of an extension duration from the network node; and
determining, by the processor, that an uplink (UL) transmission is allowed in the extension duration subsequent to an expiry of the GNSS validity duration.

2. The method of claim 1, wherein the configuration of the extension duration is received via a dedicated radio resource control (RRC) signaling.

3. The method of claim 2, wherein the dedicated RRC signaling comprises an information element (IE) for a time alignment timer, and a value of the extension duration is determined based on a remaining time of the time alignment timer in an event that the time alignment timer is not configured to be infinity.

4. The method of claim 2, wherein the configuration of the extension duration indicates a value of the extension duration to be applied in an event that a time alignment timer is configured to be infinity.

5. The method of claim 4, wherein the configuration of the extension duration comprises a 3-bit field indicating the value of the extension duration.

6. The method of claim 1, further comprising:
starting, by the processor, a timer with a value of the extension duration; and
leaving, by the processor, the connected state in an event that the timer expires, no indication of a network triggered GNSS measurement has been received, and autonomous GNSS re-acquisition is disabled.

7. The method of claim 1, wherein the determining that the UL transmission is allowed in the extension duration subsequent to the expiry of the GNSS validity duration is performed in an event that a frequency error and a timing error of a GNSS position associated with the GNSS validity duration are within frequency and timing error requirements with a closed loop time correction.

8. The method of claim 1, further comprising:
determining, by the processor, that the UL transmission is not allowed after the expiry of the GNSS validity duration, in an event that the configuration of the extension duration is not received;
determining, by the processor, that the UL transmission is allowed in the extension duration subsequent to the expiry of the GNSS validity duration, in an event that the configuration of the extension duration is not received and an indication of enabling UL transmission extension is received, wherein the extension duration is set to a predetermined value.

9. The method of claim 8, wherein the indication of enabling UL transmission extension is received via a dedicated RRC signaling.

10. An apparatus, further comprising:
a transceiver which, during operation, wirelessly communicates with a network node of a wireless network; and
a processor communicatively coupled to the transceiver such that, during operation, the processor performs operations comprising:
connecting, via the transceiver, to the network node of the wireless network to operate in a connected state with a global navigation satellite system (GNSS) validity duration;
receiving, via the transceiver, a configuration of an extension duration from the network node; and
determining that an uplink (UL) transmission is allowed in the extension duration subsequent to an expiry of the GNSS validity duration.

11. The apparatus of claim 10, wherein the configuration of the extension duration is received via a dedicated radio resource control (RRC) signaling.

12. The apparatus of claim 11, wherein the dedicated RRC signaling comprises an information element (IE) for a time alignment timer, and a value of the extension duration is determined based on a remaining time of the time alignment timer in an event that the time alignment timer is not configured to be infinity.

13. The apparatus of claim 11, wherein the configuration of the extension duration indicates a value of the extension duration to be applied in an event that a time alignment timer is configured to be infinity.

14. The apparatus of claim 13, wherein the configuration of the extension duration comprises a 3-bit field indicating the value of the extension duration.

15. The apparatus of claim 10, wherein, during operation, the processor further performs operations comprising:
starting a timer with a value of the extension duration; and
leaving the connected state in an event that the timer expires, no indication of a network triggered GNSS measurement has been received, and autonomous GNSS re-acquisition is disabled.

16. The apparatus of claim 10, wherein the determining that the UL transmission is allowed in the extension duration subsequent to the expiry of the GNSS validity duration is performed in an event that a frequency error and a timing error of a GNSS position associated with the GNSS validity duration are within frequency and timing error requirements with a closed loop time correction.

17. The apparatus of claim 10, wherein, during operation, the processor further performs operations comprising:
determining that the UL transmission is not allowed after the expiry of the GNSS validity duration, in an event that the configuration of the extension duration is not received; or
determining that the UL transmission is allowed in the extension duration subsequent to the expiry of the GNSS validity duration, in an event that the configuration of the extension duration is not received and an indication of enabling UL transmission extension is received, wherein the extension duration is set to a predetermined value.

18. The apparatus of claim 17, wherein the indication of enabling UL transmission extension is received via a dedicated RRC signaling.

19. A method, comprising:
receiving, by a processor of an apparatus, a medium access control (MAC) control element (CE) from a network node of a wireless network, wherein the MAC CE indicates that a global navigation satellite system (GNSS) measurement gap is triggered;
determining, by the processor, that the GNSS measurement gap starts at a time equal to a value plus an end of a subframe or slot where a hybrid automatic repeat request (HARQ) feedback for the MAC CE is transmitted to the network node; and
performing, by the processor, a GNSS measurement based on the GNSS measurement gap.

20. The method of claim 19, wherein the value is predefined to be 2 milli-seconds (ms) or is configured via a radio resource control (RRC) signaling.
